(19) United States
(12) Patent Application Publication
(10) Pub. No.: US 2004/0173065 A1
(43) Pub. Date: Sep. 9, 2004

(54) Clamp system

(75) Inventor: Jason E. Hill, University City, MO (US)

Correspondence Address: HOME DEPOT USA, INC., 2455 PACES FERRY RD. NW, STORE SUPPORT CENTER, C-19, ATLANTA, GA, 30339, US

(73) Assignee: EMERSON ELECTRIC CO., St. Louis, MO (US)

(21) Appl. No.: 10/248,969

(22) Filed: Mar. 6, 2003

(51) Int. Cl. B26D 1/00

(52) U.S. Cl. 83/13

(57) ABSTRACT

A clamp system for securing a work piece to a tool includes a rod having first and second ends. A clamping device is attached to the first end of the rod, and a key member, such as a roll pin, extends from the second end. An opening is defined by the tool for receiving the second end of the rod. The opening has first and second segments, with the first segment defining a keyway corresponding to the key member such that the key member passes though the keyway when the second end of the rod is inserted into the first segment of the opening. The rod is rotatable within the opening when the key member is received by the second segment of the opening to rotate the key member out of alignment with the keyway to secure the rod to the tool.

### BACKGROUND OF INVENTION

1. Field of the Invention

The present invention relates generally to clamps, and more specifically, to a clamp system for securing a work piece to surface, such as the work surface of a power tool.

2. Description of Related Art

When performing operations on a work piece, such as with a hand or power tool, it is often desirable to secure the work piece to a stable surface such as the work table of the tool. Using a clamp to secure the work piece often increases the safety and accuracy of an operation by preventing the work piece from moving around. Despite the advantages, clamps that are currently known and commercially available are not always used because they can be difficult to install, remove or maneuver. That disadvantage becomes particularly significant when multiple pieces are being worked on with a power tool, because currently known clamps can be awkward and time consuming to use.

One type of existing clamp is not attached to the power tool or its work surface. Instead, it functions similar to a vise. For example, one jaw of the clamp is placed underneath the base of the work surface and the other jaw is placed on top of the work piece and the jaws of the clamp are closed together until the work piece is firmly held in place. However, this type of clamp is often awkward to use and may not adequately fix the work piece as desired. Moreover, since it is not attached to the power tool, it can easily be lost or misplaced.

Another type of clamp is installable on the power tool or its work surface. The advantage of this second type of clamp is that it is more convenient to use, because the entire clamp does not have to be removed each time a new piece is worked on. Since one end of the clamp is fixed to the power tool, the other end of the clamp only needs to be opened enough to release and exchange work pieces. Unfortunately, known clamps of this type often have limited maneuverability and are difficult or convenient to use. The present invention addresses these and other shortcomings associated with the prior art.

### SUMMARY OF INVENTION

In accordance with aspects of the present invention, a clamp system for securing a work piece to a tool such as a miter saw is disclosed. The clamp system provides an improved means of attaching or removing a clamp to the tool that is intuitive and straightforward.

The clamp system includes a rod with a clamping device attached to one end and a key member extending from the other end of the rod. A roll pin may form the key member, which extends generally transversely to the rod in exemplary embodiments. An opening is defined by the tool for receiving the end of the rod opposite the clamping device. The opening has first and second segments, with the first segment defining a keyway corresponding to the key member such that the key member passes though the keyway when the rod is inserted into the first segment of the opening. The rod is rotatable within the opening when the key member is received by the second segment of the opening to secure the rod to the tool. Thus, a user can rotate the rod once the key member has passed through the keyway into the second segment of the opening so that it is out of alignment with the keyway, thereby fastening the rod to the work surface. This allows the clamping device of the system to be employed to secure a workpiece to the work surface.

As noted above, the tool may comprise a saw, such as a miter saw in which the blade is movable relative to the work surface. When the clamp system is used in conjunction with a saw, the opening for receiving the rod may extend through a fence that is mountable to the tool, allowing the work piece to be clamped against the work surface and/or the fence.

The rod may have a generally cylindrical shape, and accordingly, the first and second segments may also be cylindrical bores defining respective diameters, with the first diameter being smaller than the second diameter.

### BRIEF DESCRIPTION OF DRAWINGS

Other objects and advantages of the invention will become apparent upon reading the following detailed description and upon reference to the drawings in which:

FIG. 1 is a perspective view of a miter saw with a clamp system installed thereon in accordance with an exemplary embodiment of the present invention.

FIG. 2 is a closer view of the clamp system shown in FIG. 1, installed on the miter saw fence.

FIG. 3 is a side view of the rod and clamping device components of the clamp system in accordance with aspects of the present invention.

FIG. 4 is a perspective top view of a fence, showing an opening therethrough in accordance with aspects of the present invention.

FIG. 5 is a perspective bottom view of the fence and the opening therethrough.

FIG. 6 is a perspective top view of the clamp system rotated to a position necessary for installation to the fence.

FIG. 7 is a perspective bottom view of the clamp system installed on the miter saw fence.

FIG. 8 is a perspective bottom view of portions of the clamp system, illustrating a clamp rod in accordance with aspects of the present invention.

FIG. 9 is a perspective top view of a portion of a fence defining an opening cooperating with the clamp rod shown in FIG. 8.

FIG. 10 is a side view partially in section of the clamp rod and fence shown in FIGS. 8 and 9.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

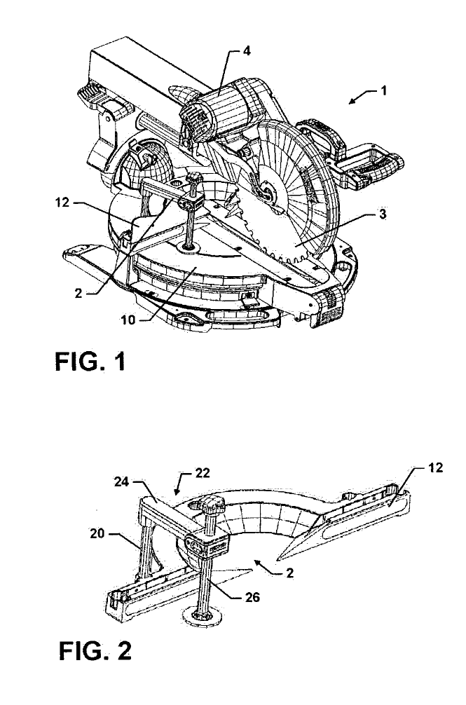

Referring to FIG. 1, a saw system is shown including a clamp system 2 in accordance with exemplary embodiments of the invention. The clamp system 2 is shown mounted to a work surface 10 of a saw 1 so that it may be used to clamp a work piece to the work surface 10. In the exemplary embodiment illustrated in FIG. 1, the saw comprises a miter saw having a blade 3 that is movable relative to the work surface 10. The blade is driven by a motor 4.

In the embodiment illustrated in FIG. 1, the clamp system 2 is mounted to a fence 12 of the work surface 10. In alternative embodiments, the clamp system 2 is employed with other types of cutting or shaping tools, such as a table saw, radial arm saw, band saw, scroll saw, etc. In some of such embodiments, the clamp system may be mounted directly to the tool's work surface, rather than to a fence attached to the work surface.

Referring to FIG. 2, the clamp system 2 and fence 12 are illustrated. The clamp system 2 includes a rod 20 having a clamping device 22 attached to the rod 20. In the illustrated embodiment, the clamping device 22 is rotatably attached to the rod 20 facilitating clamping of different sized and shaped work pieces.

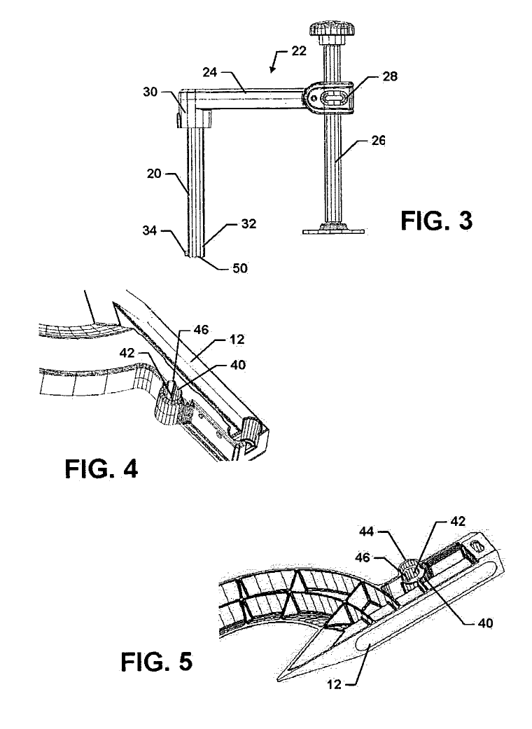

Referring to FIG. 3, the rod 20 in the illustrated embodiment is cylindrical and has a first end 30 to which the clamping device 22 is attached. The rod 20 has a second end 32 having a key member 34 extending therefrom generally transversely to the axis of the rod 20. In the particular embodiment shown in FIG. 3, the key member 34 comprises a roll pin extending from the second end 32 of the rod 20. The key member 34 is sized and shaped to be received by a corresponding keyway to lock the clamping system 2 to an item such as a power tool work table for clamping a work piece thereto.

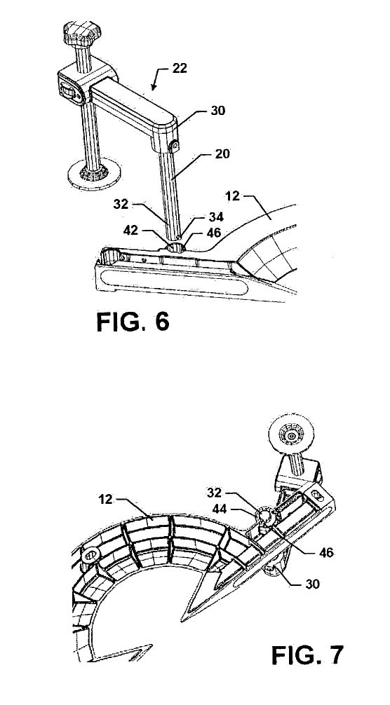

FIG. 4 illustrates a top portion of the fence 12, and FIG. 5 shows the corresponding bottom portion. The fence 12 defines an opening 40 for receiving the second end 32 of the rod 20. The opening 40 has a first segment 42 defining a first diameter and a second segment 44 defining a second diameter. The first segment 42 diameter is smaller than the second segment 44 diameter. The first segment 42 is sized to receive the rod 20, and further defines a keyway 46 sized to receive the key member 34. The diameter of the first segment 42 is smaller than the diameter of the rod 20 plus the depth of the key member 34, but larger than the diameter of the rod 20. Thus, the rod 20 can only pass through the first segment 42 of the opening 40 when the key member 34 is aligned with the keyway 46. FIG. 6 illustrates the key member 34 aligned with the keyway 46.

The diameter of the second segment 44 is larger than the diameter of the rod 20 plus the depth of the key member 34, as shown in FIG. 7. Once the second end 32 of the rod, including the key member 34, is received by the second segment 44, the rod 20 is rotatable in the opening 40. Rotating the key member 34 out of alignment with the keyway 46 secures the rod 20 to the fence 12.

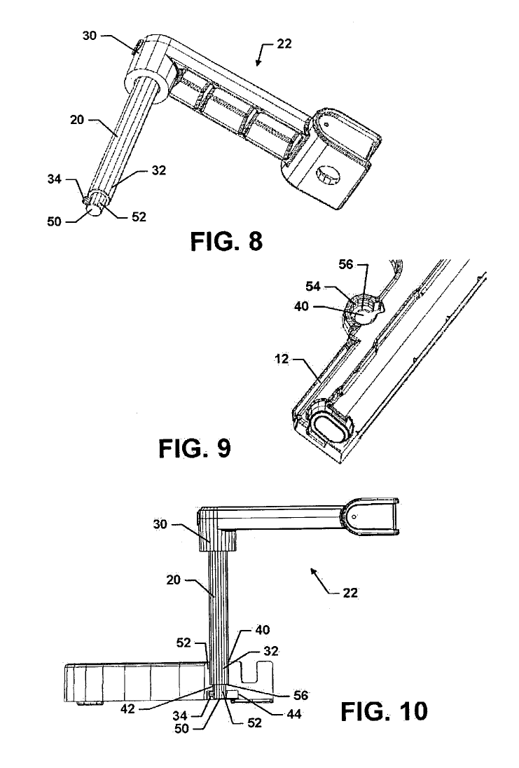

FIGS. 8-10 illustrate another exemplary clamp system in accordance with aspects of the invention. In the previously disclosed embodiment (see, for example, FIG. 3), the rod 20 was located axially (up and down relative to the work surface 10) by the lower surface 50 of the second end 32 contacting the work surface 10 of the saw. To prevent the lower surface 50 from contacting the work surface 10, the embodiment shown in FIGS. 8-10, the second end 32 of the rod 20 has an area 52 with a reduced diameter as compared to the first end 30. The opening 40 in the fence 12 defines a mating counterbore, forming a third segment 54 of the opening 40. The junction of the first segment 42 and third segment 54 of the opening defines a ledge 56, which creates an axial constraint on the clamp rod 20 internal to the fence 12 and eliminates any contact of the rod 20 to the work surface 12.

In the exemplary embodiments illustrated, the clamping device 22 includes an 24 rotatably attached to the first end the rod 20. A clamp rod 26 is slidably received by the arm 24, and a locking mechanism 28 functions to fix the clamp rod 26 in a desired position. The rotatable attachment of the clamping device 22 to the rod 20 allows a user to rotate the clamping device out of the way when not in use, or allows the user to clamp the work piece at different places. Thus the clamping system of the present invention allows the user to quickly secure multiple work pieces in succession to the power tool and to clamp work pieces that are difficult to clamp because of their shape or surface.

Thus, the clamp system of the present invention provides improvements over the prior art. Minimal machining is required, thereby reducing cost. No additional tools are required to install or remove the clamp, and very little effort is required by the user to install or remove the clamp. Since alignment of the key member 34 and keyway 46 is clearly visible, mounting is intuitive and straightforward.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A clamp system for securing a work piece to a tool, comprising:
a rod having first and second ends;
a clamping device attached to the first end;
a key member extending from the second end;
an opening defined by the tool for receiving the second end, the opening having first and second segments; and
the first segment defining a keyway corresponding to the key member such that the key member passes though the keyway when the second end of the rod is inserted into the first segment of the opening;
wherein the rod is rotatable within the opening when the key member is received by the second segment of the opening to secure the rod to the tool.

2. The clamp system of claim 1, wherein the opening extends through a fence mountable on the tool.

3. The clamp system of claim 1, wherein the key member comprises a roll pin.

4. The clamp system of claim 1, wherein the key member defines an axis generally transverse to an axis defined by the rod.

5. The clamp system of claim 1, wherein the rod is generally cylindrical.

6. The clamp system of claim 1, wherein the first and second segments define first and second diameters, respectively, the first diameter being smaller than the second diameter.

7. The clamp system of claim 1, wherein the clamping device is rotatably attached to the first end of the rod.

8. The clamp system of claim 1, wherein the clamping device includes an arm rotatably attached to the first end of the rod.

9. The clamp system of claim 1, wherein the clamping device includes an arm attached to the first end of the rod, and a clamp rod slidably received by the arm.

10. A method of attaching a clamp to a tool for clamping a workpiece to the tool, the clamp including a rod having a key member extending therefrom, the method comprising:
aligning the key member with a corresponding keyway defined by a first segment of an opening in the tool;
inserting the rod into the first segment so that the key member passes through the keyway and into a second segment of the opening;
rotating the rod such that the key member is out of alignment with the keyway to secure the rod to the tool.

11. The method of claim 10, wherein the tool includes a fence mountable thereon, the opening extending through the fence, and wherein inserting the rod includes inserting the rod into the fence.

12. A clamp system for securing a work piece to a tool, comprising:
a rod having first and second ends;
a clamping device attached to the first end;
first means defined by the second end for securing the rod to the tool; and
second means defined by the tool for rotatably receiving the rod to lock the rod to the tool.

13. The clamp system of claim 12, wherein the second means defines means for receiving the first means.

14. The clamp system of claim 12, wherein the second means is defined by a fence mountable to the tool.

15. A saw system, comprising:
a cutting blade;
a work surface for supporting a work piece;
a rod having first and second ends;
a clamping device attached to the first end;
a key member extending from the second end;
an opening defined by the work surface for receiving the second end, the opening having first and second segments; and
the first segment defining a keyway corresponding to the key member such that the key member passes though the keyway when the second end of the rod is inserted into the first segment of the opening;
wherein the rod is rotatable within the opening when the key member is received by the second segment of the opening to secure the rod to the work surface.

16. The saw system of claim 15, further comprising a fence mountable on the work surface, the fence defining the opening.

17. The saw system of claim 16, wherein the first end of the rod defines a diameter and the second end of the rod defines a smaller diameter, and wherein the opening defines a third segment, the third segment having a diameter generally corresponding to the diameter of the first end of the rod, the second segment having a diameter generally corresponding to the diameter of the second end of the rod.

18. The saw system of claim 15, wherein the blade is movable relative to the work surface.

19. The saw system of claim 15, wherein the key member comprises a roll pin.

20. The saw system of claim 15, wherein the rod is generally cylindrical.

21. The saw system of claim 15, wherein the first and second segments define first and second diameters, respectively, the first diameter being smaller than the second diameter.
